(19) United States
(12) Patent Application Publication
(10) Pub. No.: US 2010/0076893 A1
(43) Pub. Date: Mar. 25, 2010

(54) METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE

(75) Inventors: ALYSSON ANSELMO PEREIRA, Curitiba (Parana) (BR); DGEISON DE LUCCA, Curitiba (Parana) (BR); AMILCAR ROSA PEREIRA, Sao Paulo (BR); OSVALDO PINALI DOEDERLEIN, Curitiba (Parana) (BR); VAGNER LUIS VALIM CARLOS, Sao Paulo (BR); WANDERLEI DE SOUZA FILHO, Campinas (Sao Paulo) (BR); LUIS RICARDO MACHADO BUENO, Sao Paulo (BR); FERNANDO MEYENBERG SANTA ROSA, Curitiba (Parana) (BR); PATRYCK VEIGA ROSA, Curitiba (Parana) (BR); MARCELO POVOAS DE AZEVEDO, Sao Paulo (BR); ELCIO SEIJI TABUTI, Sao Paulo (BR); IGOR DE FREITAS ROSA, Curitiba (Parana) (BR); VICTOR VILAS BOAS VARGAS, Sao Paulo (BR); VIVIANE LOPES SCHITINE LEMOS, Sao Paulo (BR); LUIZA ASANO ISUYAMA, Sao Paulo (BR)

Correspondence Address: CANTOR COLBURN, LLP, 20 Church Street, 22nd Floor, Hartford, CT, 06103, US

(73) Assignee: TECNOLOGIA BANCARIA S.A., Barueri (Sao Paulo) (BR)

(21) Appl. No.: 12/503,338

(22) Filed: Jul. 15, 2009

(30) Foreign Application Priority Data
Jul. 15, 2008 (BR) PI 0802531-2

(51) Int. Cl. G06Q 40/00; H04L 9/16

(52) U.S. Cl. 705/71; 705/44; 705/21

(57) ABSTRACT

A method for the routing of messages coming from capture points directly, or indirectly, connected to the Tecban network, and authorized by the Financing Institutions, which are also connected to the Tecban network, remarkably conceived to consolidate the ATM network of Tecban, as well as the proprietary networks of the Financing institutions administered by Tecban, through a number of encoded instructions, contained in a software used in computer networks to exchange messages among the several elements involved.

### TECHNICAL FIELD OF THE INVENTION

The present descriptive report relates to a patent request of a method for processing and routing financial transactions from captures points and authorized by Financial Institutions, mainly conceived to consolidate the self service Tecban network, as well as networks owners of Financial Institutions managed by Tecban, through a set of coded instructions, present in a software used in computer networks for message exchanges among the several involved elements.

### BRIEF DISCUSSION OF RELATED ART

As it is known by the professionals of the bank technology field, the technological challenges posed by the degree of innovation of the services are permanent.

Tecban first challenge in the beginning of its operation was to build a totally local application able to control actions at the terminal, such as card insertion, money counting, receipt printing, local transaction registration for posterior collection and effectivation, etc.

At that time it was easy to keep the Rede Banco24horas [24-Hours Bank] Network ATMs operational, since they were in a very small number. However, as the network size increased, a huge backup infrastructure was developed, so as to ensure safety and availability of its points.

This infrastructure gradually evolved, until it incorporated a software component called authorizer which, in is childhood, was responsible by the authorization of every transaction performed at the network terminals of the Banco24Horas network. Since its incorporation, this same component is evolving as new business demands appear The on line authorization with the Financial Institutions, the routing logic creation and prevalidations of the received messages are some examples of evolutions made necessary in the past.

With the diversity of institutions that started using the Banco24Horas network terminals and with the creation of new products and services, the complexity and the critical position of the authorizer steadily grew over the time. Although it was segmented from the creation of new products that were related to electronic funds transference, the complexity of this new strand presented a behavior similar to what was observed in the first case.

Motivated by the need to modernize this component, it was initiated a study of solutions that may be able to replaces, allowing more celerity in the evolutions demanded by the Company affairs. This project motivated a reconceptualization of the business rules currently implemented in the authorizer, searching to follow the Company strategic orientation: to act more at the routing and less at the transaction authorization. The possibility of engagement of Tecban in outsourcings of other networks ignited the immediate onset of this restoration.

Due to its being a relatively old solution, created by using programming languages and building techniques that were more widespread by the time of its conception, the authorizer has some limitation, for instance, high service agroupation, low horizontal organization to handle the expected transactional volume increase, difficulty in integration with other market solutions, and the communication protocol dependence.

Therefore, the solution implemented until now directly affects the development teams responsible by the font code maintenance; the confirmation teams, that perform validations on the alterations made. the backup teams that need new information on the performed transactions or on consultations in a periodicity different from the usual; the production team that cannot have self-sufficiency in meeting the considerable transactional volume increase; the Company clients that rely on the requested evolution delivery to offer their services.

Besides that, since it is a monolithic code, in most of the cases the parallelization of the development activities is impaired. The justification of this claim is that different development branches must eventually converge, and it will demand a great amount of work to perform the fusion of these two branches.

Another aspect of primordial importance is that most of the source code modifications—regardless of their magnitude—demand the performance of complete regressive testes, which attest the correct performance of what was already performing well before. The great complexity of the code is detrimental to its learning curve, that is, it takes a long time to capacitate new collaborators for maintenance.

Therefore, it is not possible to increase the transaction volume, because the repository of the authorized data does no present characteristics that allow easy segmentation of its content in several distributed instances. Besides that, this repository does no allow integration with market tools as, for instance, ETL (Extract, transform, load) or BI (Business Intelligence). Integrations of this king demand complementary strategies and efforts.

Besides that, the lack of flexibility in the treatment of messages exchanged with terminals and with the Financial Institutions (less configurable logic), a great effort of adaptation by the authorizer being also demanded, is the communication protocol is different from ISO 8583

### BRIEF SUMMARY OF THE INVENTION

Aiming to offer improvements to the consumer market, the inventor, after several researches, created and developed this “METHOD FOR PROCESSING AND ROUTING OF FINANCIAL TRANSACTIONS FROM CAPTURE POINTS AND AUTHORIZED BY FINANCIAL INSTITUTIONS, IMPLEMENTED THROUGH SOFTWARE”, which may stand in the market in a highlighted position, due to its ensuring fast integration between the extremes involved in transaction performances.

The method mentioned was created in object oriented language and it is also built to perform, in a first instance, transactions between self-service terminals of the owner networks to which the Company provides outsourcing services and the Financial Institution that own this networks.

This new software structure deals with input and output of standardized data regarding data layout, format and translation, all of them taking place inside the software algorithm.

Therefore, the mechanism and tool mentioned are related to parts of the algorithm, or else, to smaller softwares that integrate the main software, being the data flow typical of software. Therefore, data validation and authentication configurations by the terminal users, besides cryptographic treatment, take place.

There is still an interface, such as a graphic screen, that is generated by software codelines.

The solution here requested, more precisely, the switch software, is the name given to the tool that allows routing the requests coming from any capture point connected directly of indirectly to the Company network to its due destination, and posteriorly, the destination of the answers to its terminals of origin, enabling the requested transactions performance. This tool is able to rapidly meet the demand for development for new transaction packs, as new institutions hand the care of part or of its entire self-service network to the Company.

It may be viewed as a Framework for financial transaction development. With this concept, the solution becomes responsible by the linking of actions to be done when messages or requests reach it and needed to be directed to a specific destination. It allows, therefore, the configuration of the information set present in the transaction message request, which is relevant to determine its destiny (the entity responsible for the authorization). This mechanism also allows the setting of value combination that this information must have for the destination to be precisely inferred. The request information set is composed, initially, by a BIN (Bank Identification Number), a service (transaction), a network and a terminal (to enable service pilots).

### BRIEF DESCRIPTION OF THE DRAWING

To complement the present description to obtain a better comprehension of the characteristics of this invention and according to a practical preferable performance of the aforementioned invention, an attached design follows the description, in which, in an exemplified, although not imitative, manner, the following was portrayed.

FIG. 1 shows an input/output switch graph.

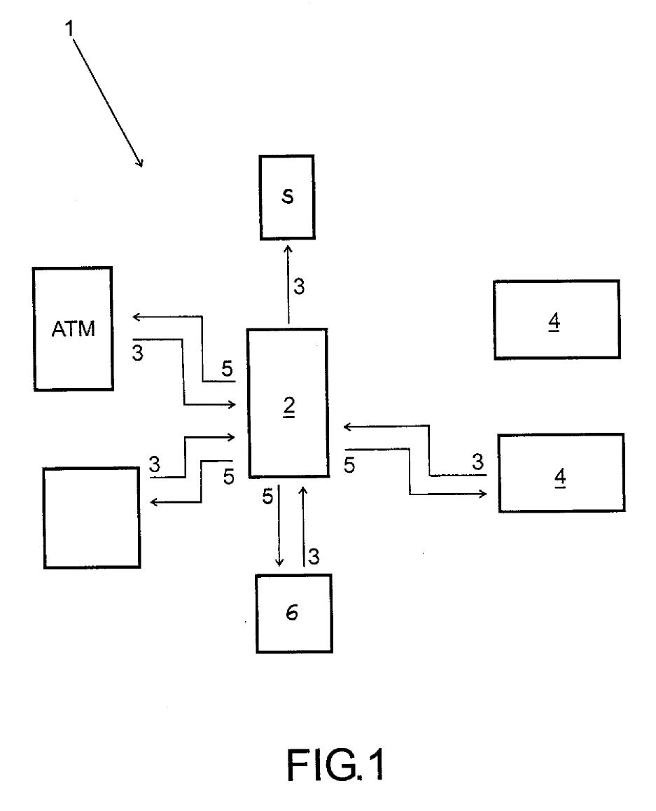

### DETAILED DESCRIPTION OF THE INVENTION

Referring to the illustrated design, the present invention, “METHOD FOR PROCESSING AND ROUTING OF FINANCIAL TRANSACTIONS FROM CAPTURE POINTS AND AUTHORIZED BY FINANCIAL INSTITUTIONS, IMPLEMENTED THROUGH SOFTWARE”, must stand in the market in a highlighted position, due to its ensuring fast integration between the extremes involved in transaction performances.

The method mentioned was created in object oriented language and it is also built to perform, in a first instance, transactions between self-service terminals of the owner networks to which the Company intends to provide outsourcing services and the Financial Institution that own this networks.

This new software for switch structure deals with input and output of standardized data regarding data layout, format and translation, all of them taking place inside the software algorithm. Therefore, the mechanism and tool mentioned are related to parts of the algorithm, or else, to smaller softwares that integrate the main software, being the data flow typical of software.

Therefore, data validation and authentication configurations by the terminal users, besides cryptographic treatment, take place.

There is still an interface, probably a graphic screen, which is generated by software codelines.

The switch solution here requested is the name given to the tool that allows routing the requests coming from any capture point connected directly of indirectly to the Company network to its due destination, and posteriorly, the destination of the answers to its terminals of origin, enabling the requested transactions performance. This tool is able to rapidly meet the demand for development for new transaction packs, as new institutions hand the care of part or of its entire self-service network to the Company. It may be viewed as a Framework for financial transaction development.

With this concept, the solution becomes responsible by the linking of actions to be done when messages or requests reach it and needed to be directed to a specific destination. This sequence of steps will be further detailed at the end of this section, after other functionalities of the solution were presented.

It allows, therefore, the configuration of the information set present in the transaction message request, which is relevant to determine its destiny (the entity responsible for the authorization). This mechanism also allows the setting of value combination that this information must have for the destination to be precisely inferred. The request information set is composed, initially, by a BIN (Bank Identification Number), a service (transaction), a network and a terminal (to enable service pilots).

The following examples of configuration of the information set for determining the destination may be mentioned: a set 1: {BIN, Service, Network}; Set 2: {Service, Network, Terminal}; Set 3: {BIN, Service, Network, Terminal}, etc. Examples of value configuration using Set 3 are present in the following table:

| BIN | Service | Network | Terminal | Destination |
|---|---|---|---|---|
| 9991 | Withdrawal | — | — | X |
| 9991 | Withdrawal | — | 010100 | W |
| 9991 | Withdrawal | Monomono | 010104 | Y |
| 9992 | — | Monomono | — | Z |

By the table it is possible to comprehend that such a configuration enables the definition of more restrict of more generic destinations, depending on the information that take a fixed value. To say “an information does not take a fixed value” means every possible value for this information must be considered.

When we try to define a destination through the consultation to this configuration, the more generic destination must be regarded first, and then the more generic According to the first line of the above table we may conclude that the Withdrawal requests for BIN 9991 must always be directed do X destination. However, this statement will not be true if the request originated in the terminal 0010100 (in this case she must be forwarded to destination W).

Before further detailing the treatments that will be explored in the input and output treatments, it is necessary first to understand what mean switch input and output.

Switch input means a message or request that reaches it, from ATM (Automated Teller Machine) terminals, POS (Point of Sale) or Financial Institutions. Transactions requests, responses or confirmations may also be, inputs, if they are reaching the switch.

Switch output means a message or request that comes from the switch, be it to a terminal, to a Financial Institution, to the transactions repository of to other backup systems. Transactions requests, responses or confirmations may also be outputs, if they are coming from the switch.

Each input will have a format and a layout that must be known for this input to be considered valid and for the switch to be able to give it due treatment. The input format defines protocol or pattern used by it. Examples of formats are ISO 8583, IFX, XML of positional.

Input layout defines the set of information that comprises it, that is, which fields will be present, which are their kinds and in which order they will be.

As different inputs may be treated by the switch, it is possible to configure, to each existent format, the different information sets that may make up expected inputs. These sets, as described before, are the layouts. Every time the format and the layout of an input were known, it will be possible to perform the isolation of specific information from the general context, what will also enable other switch actions, as, for example, the destination decision. This configuration will also enable an input to be validated regarding its integrity at the moment it reaches the switch.

The possibility of isolating essential information for the transaction processing allows different input formats and layouts to feed a sole internal structure, which is used as a source to the switch internal logic. The following item deals with normalization of the system inputs and details this process of information isolation.

The input layout and format configuration basically define, for each input, the used protocol, the fields that comprise it, the order of these fields, their sizes and shapes.

When we talk about different formats it must not be concluded that the information set present in each of them are also completely different. To allow the correct routing by the switch, it is necessary a minimal information set used by it to precisely define destination. Therefore, a basic rule to allow integration via switch is that the minimal information set to determine destination will always be present in inputs, regardless of format and layout that organize information within the inputs. To obtain this minimal set, the switch uses the input format and layout configurations, which specify which is the field set and in which order and/or position they are defined. This process is named input normalization. The result of this extraction is a basic structure, which that switch uses as reference whenever there is the need to access any content, the complete analysis of the input not taking place each time an information is used. Thus, the normalization may also be defined as the transformation of an input into the information internal structure.

For the valid format and layout configuration to be identified for a specific input it is necessary for some information to be present in it. These indications must be situated in an identifiable position at the input.

The switch is prepared to normalize inputs that respect standard ISO 8583 and also to process positional contents and contents in XML format.

The switch solution allows the input format and layout configuration to be used for a determined recipient, allowing the definition of the information set that must be part of these inputs, the order in which they will be given and their kinds.

Before defining the concept of translation and the related requirements, it is important to understand the difference between format, layout and content. A format defines a standard, such as ISO 8583. A layout establishes the information set that make up an input or an output (that is, the fields and their kinds). Content means the values that the fields take in a specific input of output. Once this difference is understood, the concept of translation may be explored.

When we try to meet a great diversity, situations in which different contents, layouts and formats are expected by the Financial Institutions tend to be ordinary. When sending an input to its destination, the switch checks the need for performing content, layout and format, as defined by the input, adaptations, all according to its recipient. The adaptations performed in the inputs are called translations and their function is building outputs in accordance to what their recipients expect. It is important to understand that, although the text states that translation happens on the output, it in fact happens on the information present in the internal structure, as defined by the input after its normalization. It must be clear that inputs change into internal structure after normalization and outputs result from translation of information of the internal structure for the format and layout the recipient expects. It is said that translation happens on the input just to make the understanding of the solution easier, by abstracting intermediate steps.

To avoid the necessity of different formats, layouts and contents to be known by the applications at its terminals, the Company usually performs translations of the inputs coming from capture points, basically depending of the recipient Financial Institution.

There is, therefore, besides the output format and layout configuration, another configuration mechanism for translation that allows the content transformation rule definition, including fixed values for fields, value linking, response code conversion, establishment of correspondence with values defined in the information internal structure, that is, the output content definition based in information present in the switch internal structure, previously defined by the correspondent input, among other transformations.

When making an output out of an input, the switch takes into account both the content transformation configuration and the output format and layout configurations defined for the recipient.

Knowing the steps performed by the switch, it is possible to imagine a high level flow executed from a new input (supposing the input is in an ATM). In the following flow the mechanisms of information distribution to the other systems will not be represented, for simplification of the reasoning.

1—An input reaches the switch;
2—The switch identifies the input format;
3—The switch identifies the input layout;
4—The switch normalizes the input;
5—The switch identifies the input destination;
6—The switch stores/updates information in internal repository;
7—The switch analyzes input and content transformation configurations for that destination;
8—The switch assembles the output, performing the necessary translations;
9—The switch sends the output to destination.

From this point on, what happens is basically repetitions of this flux to the remaining transaction since, when receiving a response from the request, the switch considers it as a new input (the same thing happens to the confirmation). The recipients are inverted during the total flow (from the terminal to the Financial Institution and from the Financial Institution to the terminal).

This view may seem simple, but it is not that simple, in fact. It is possible to point out some problems in this flow. Suppose, for example, that the transaction request had already left to the Financial Institution, what leads to the conclusion that the translation process to output is already performed. When sending a response, this Financial Institution will be sending a new input to the switch, based in its communication form—it would demand new adaptations before normalization, for the contents to be recognized internally. It is concluded therefore that the solution is prepared to perform actions opposed to the performed in the translation, at the moment of normalizing the new input. If the normalization process is understood as a point where adaptations of content may also happen, the flow described above may be considered valid.

When we speak about inputs from ATMs from Banco24Horas network, there are no great worries about the normalization mechanism, since the application was already built to make inputs with internally known inputs. This statement is also valid to outsourcing of owner networks in which the Company develops the application they perform at the terminals. The greatest worry about this mechanism is due to the Financial Institution currently generating inputs whose content vary greatly. Supposing a somewhat different scenario, where the Company performs outsourcing of a network by the application of a terminal is maintained by the institution itself, the worry with this mechanism tends to increase even more. Therefore, a configuration mechanism resembling the translation mechanism was also built for this case.

Whenever there is an input at the switch, it must be able to perform some basic validations on this input. Among these validations, the following may be mentioned:

1—Presence of the minimal information set for routing;
2—Kinds of information;
3—Message integrity.

Whenever there is an input at the switch, this will check if the indicated origin is valid, that is, if it came from a capture point or from a Financial Institution that really exists and that is really qualified to perform transactions.

An initial transaction set (and specific configurations) was built together with the switch solution, aiming, basically, to ensure some safety requirements that currently exist.

The switch solution deals with routings of inputs that demand authentication of a user present in a self-service terminal. It was built, with that purpose, a transaction that authenticates the user based in a valid card database. This transaction reports authentication errors happened to allow that, afterwards, they may be consulted and they may serve as source of statistics.

The solution provides mechanisms to handle the user card database, offering the basic functionalities of a database (inclusion, exclusion and consultation). Among the transactions developed together with the switch solutions is the cryptography key replacement. This transaction is available to ensure the periodic ATM transport and master key replacement.

The switch solution is able to change the password transport key present in the input (coming from a terminal) to the transport key from the Financial Institution, in the output making. The cryptography may be performed by software or hardware, depending on the configuration defined to the Financial Institution or terminal.

When the password treatment is configured to be performed by hardware, the transport key replacement will be conducted by a hardware known as HSM (Hardware Security Module). In case of cryptography by software the transport key replacement will be performed by the Company cryptography server. The switch solution provides some statistical information on input and output processing:

1—Minimal time, mean time a maximal time of each input or output in the system
2—Response time from the Financial Institution;
3—Number of inputs/outputs per period;
4—Number of timeouts.

The switch sends transaction information to every backup system that uses them, promoting the least modification in theses systems,

The switch is able to report occurrences informed by terminals for the backup system responsible for its management. That is why there is a service responsible for the treatment of inputs that correspond to occurrences

To the configuration mechanism previously described (except for the layout configuration mechanisms) it must be possible to schedule the modifications performed so that the new configurations enter into force only at the appointed time.

The solution will record all the modification historical record, being possible to identify which ones were the values available in any moment of the past. Analyses performed during the project identified some deficiencies in the configuration mechanisms currently available to the previous authorizer. Details on this diagnostic may be obtained by reading the documents indicated in the section “ERROR! A ORIGEM DA REFERÊNCIA NÃO FOI ENCONTRADA”. Aiming to solve the aforementioned problems, new tools were envisaged, yet to be built, and that will replace the current ones. During the project it was necessary to consider the requirements on which this new tools were based in, so that future integrations are able to happen in the clearest way.

To allow other configurations described in this document it is necessary for the system to have an auxiliary information set for its operation.

The following information are kept by the system graphic interface, with register operation, consultations, removal and information updating;

### 1—BIN/set of BINs;

### 2—Destination Address;

### 3—Authorizing Entity;

### 4—Terminal Groups;

### 5—Cryptography Configurations;

6—Information from Terminals
7—Information from Financial Institution/Authorizing Entities

The following information are obtained through the process of loading of other corporate systems.

### 1—Network;

### 2—Terminal;

3—Terminal identification;

### 4—City;

### 5—States;

### 6—Region;

### 7—Software Version;

### 8—Sponsors.

### 9—Financial Institution;

10—ATM application versions.

The following information are kept in files of in database tables (without graphic interface):

2—Response code from the Financial Institution;
2—Response Code from TecBan;

### 3—Communication Protocol Version;

4—Transaction/Service of set of transactions/services:

### 5—Message Code;

### 6—Processing Code;

### 7—Internal Service Code.

The switch solution stores relevant information of each input of output, making if available by the necessary amount of time, in a transaction repository.

The switch basically defines the sequence of actions to be performed so that a transaction may be concluded. Using a term widely used in these times, it works as an orchestrator of processing and/or rules that are performed when the input arrives or when the output leaves. In these treatments that are initiated by the switch, there are those already mentioned, beside some other relevant ones:

1—Transaction state chances at each stage performed or in case of problems;
2—“Naming” of transaction: definition of a unique identification linking every part of the same transaction;
3—Timeouts control, configured for inputs and outputs;
4—Validations for inputs from the Financial Institutions (response codes, for instance);
5—Moments in which the information must be stored.

The order of treatment of actions defined by the switch varies according to which transaction is being performed, since a withdrawal transaction is naturally different from a balance check transaction, for instance.

To promote the agility expected in the building of new transaction, the switch solution offers a standard simplified flow, used as a starting point every time a new transaction arises.

The solution offers a new transaction sample set that specialize the basic switch behavior described in the previous sections. These basic transactions are incorporated to the switch core to speed up the development of the transactions necessary to meet the Company future business demands.

The system performs the behavior needed to perform the routing of a transaction of withdrawal involving request, response and confirmation. This transaction is flexible in order to be able to work with Financial Institutions that operates with confirm/cancel and to ones who don't.

The solution is able to perform the treatment needed to routing a balance transaction composed of request, response and confirmation in the part ATM-switch at the same time the transaction is treated only with request and response in the stage switch-Financial Institution.

The system performs the behavior needed to perform the routing of a balance check transaction. The treatment provides the flow of Financial Institutions that operate with multiple response messages for the same transaction. This is necessary because there are response messages (containing the requested extract) whose value is greater than allowed in some ATM terminal implementations. Therefore, the switch will be able to work with fragmented answer by the Financial Institution.

The core of the solution must incorporate the behavior needed to the processing of a consultation of registration information. This transaction is used by the terminal to obtain registration information on the card bearer. The processing performed by the switch provides a consultation of a Company internal system to obtain the list of available transactions for the card. This transaction also provides a consultation to the Financial Institution do obtain information on the Positive Identification of the client. The switch will be responsible for the linking of the two responses. A sole response message will be sent to the terminal.

To enable independence among the components that deal with financial transactions, it was necessary to have a configuration in the solution that would indicate which component a certain input message is directed to.

The information relevant to distinguish between one service and the other are the following ones:

1—Transaction identification (message code, processing code);

### 2—Network;

### 3—Terminal;

### 4—BIN/set of BINs;

### 5—Terminal Version;

### 6—Communication Protocol Version;

In order for this choice to work it is necessary for the above information to be present in defined sites in the input system messages. The processing of choosing a service is specific to each external message standard. The system is currently able to choose system services to the ISO 8583 standard. Documents were produces, such as:

1—Development manuals to minimize the training time of new solution developers.
2—User manual;
3—System management manual;

Besides that, some other requirements were provided to the solution, among them:

1—Visual presentation (configuration interfaces) based in the utilization of Web technology (browsers) for configurations available to average users;
2—Using xml files for functionalities configuration available to developers;
3—Availability of 24×7 for the switch core;
4—The services are independent regarding maintenance, packing and implementation, with possible grouping by Network (Financial Institution A, Financial Institution B, Network Banco24Horas, etc) and sets of business transactions;
5—The switch solution provides information to backup systems through online publishing of the information on transactions, using for that a integration software;
6—Utilization of a relational database.
7—Development structure (codes, components, version environment) allowing celerity in the building of new transactions through implementation parallelism with the following business axes:
a. Transactions/Transactions Groups;
b. Self-Service network (Financial Institution A., Financial Institution B, Banco24Horas Network).

### Performance Requirements

1.—The solution can work with at least 75 financial transactions per second, considering a set of machines whose total capacity is 100,000 TPM (according to TPC definitions). These machines will be distributes for database system use and for application servers;
2.—The total amount of processing time for each stage of the transaction must no be over 1 second

Although the invention is here detailed, it is important to understand that it is not limited to the details and stages here described. This invention is able to perform other modalities and to be executed in several different ways. It must be understood that the terminology here used is for description purposes only, not limitation.

What is claimed is:

1. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, built to perform routing of transactions among the self-service terminals of the owner networks to which the Company provides outsourcing services and the Financial Institutions owner of these networks or even among the Banco24Horas (24-Hour-Bank) network and the participant Institutions, wherein it presents a method that comprises a software for transaction routing, which works with input and output of standardized data in relation to data layout, form and translation, all these actions taking place in the internal parts of the software algorithm; every mechanism and tool mentioned is related to parts of the algorithm, or else, to smaller softwares that integrate the main software, being the data flow typical of a software and, therefore, data validations, user authentication and cryptographic treatment take place, as well as an interface, such as a graphic screen generated from the software codelines; the switch links the actions to be performed when messages or requests reach it, needing to be directed to a specific destination; the switch solution allows the configuration of the information set present in the transaction request message relevant to determining its destination (the entity responsible for its authorization); this mechanism allows the setting of the combination of the values that this information must have in order for the destination to be precisely inferred; this information set is composed, initially, by a BIN (or a BIN set), a service (transaction), a network and a terminal (to enable service pilots); when a destination is attempted to be defined through the consultation of this configuration, the more specific destinations are at first considered, and the more generic are examined afterwards.

2. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the switch provides, among others, the following actions to be executed: 1—Changes of transaction state at each stage performed of in case of trouble; 2—Transaction “naming”; definition of a unique identification that ties every stage in the same transaction; 3—Control of timeouts configured between inputs and outputs; 4—Validations of Financial Institution inputs (response codes, for example); 5—Moments in which information must be stored, the treatment or action order defined by the switch varying according to the transaction being performed, since a withdraw transaction is naturally different from a balance check transaction, for instance, and to provide the expected celerity in the building of new transactions, the switch solution offers a simplified standard flow, used as a start point every time a new transaction appears; this solution offers a set of sample transactions that specialize the basic switch behavior described in the previous sections. These basic transactions are incorporated to the switch core to speed up the development of the transactions necessary to meet the Company future business demands.

3. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the switch input is a message or a request that reaches it, from ATM, POS or Financial Institutions terminals; transaction requests, responses or confirmations are inputs, if they are arriving at the switch; each input will possess a format and a layout that must be known in order for this input to be considered valid and for the switch to be able to treat it in and adequate way; the input format defines the protocol or pattern used by it. Examples of formats include ISO 8583, IFX, XML or positional; the input layout defines the information set that make up the input, that is, which fields will be present, which kinds of fields will they be, in which order will they appear; in order for the several different inputs to be treated by the switch it must be possible to configure, for each existent format, the different information sets that may be part of expected inputs; these sets, as previously described, are the layouts; every time the input layout and format are known it will be possible to use the isolation of specific information from the general context, which will also enable other switch actions, such as, for instance, the destination decision. This configuration will also allow an input to be validated regarding its integrity at the moment it reaches switch; the possibility of isolating information essential to the processing of the transaction allows different input formats and layouts to feed a sole internal structure, which will be used as a source for the internal switch logic. The input layout and format configuration basically define, for each layout, the used protocol, the fields that comprise it, the order of these fields, their sizes and shapes.

4. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the switch output is a message or request coming from the switch, be it to a terminal, to a Financial Institution, to the transaction repository or to backup systems. Transactions requests, responses or confirmations may also be outputs, if they are coming from the switch.

5. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein to the correct routing of the switch, a minimal information set is necessary for the destination to be precisely defined. Therefore, the minimal information set to determine destination will always be present in inputs, regardless of format and layout that organize information within the inputs.

6. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein to obtain this minimal set, the switch uses input format and layout configurations, which specify what is the field set and in which order and/or position they are defined (input normalization); the result of this extraction is a basic structure, that will be a reference for the switch every time there is the need to access any content, the complete input analysis not taking place each time information is used. Therefore, normalization may also be defined as the transformation of an input into the information internal structure; for the valid input format and layout configuration to be able to be identified to a specific input, some indications must be present in it. These indications must be situated in an identifiable position at the input.

7. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the switch solution allows the output format and layout configuration to be used by a specific recipient, enabling the definition of the information set that may compose these outputs, the order by which they must be organized and their kinds.

8. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein a format defines a pattern such as ISO 8583, XML, IFX, positional, etc.

9. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein a layout establishes the information set that make up an input or an output.

10. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the content means the values fields take in a specific input or output.

11. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein when a request is sent, the switch checks for the need to perform content, layout and format adaptations as defined by the input, everything according to its recipient; the adaptations performed for the outputs are called translations; these translations transform the internal structure into an output that respects recipient expected format and layout.

12. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein, so as to avoid different formats, layouts and contents from having to be recognized by terminals applications, translations of inputs coming from capture points are necessary, basically depending on the recipient Financial Institution.

13. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein, besides the output layout and format configuration, there is another configuration mechanism for translation that allows content transformation rules definition that include fixed value assignment to fields, value linking, response codes conversion, establishing correspondence to values defined in the information internal structure, that is, defining the output content based in information present in the switch internal structure, previously defined by the correspondent output, among other transformations; when composing an output from an input, the switch takes into account both the content transformation configurations and the output layout and format configurations defined for the recipient.

14. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein a request sent presents the following flow: An input reaches the switch. 2—The switch identifies the input format; 3—The switch identifies the input layout; 4—The switch normalizes the input; 5—The switch identifies the input destination; 6—The switch stores/updates transaction information in internal repository; 7—The switch analyses the output and content transformation configurations for that destination; 8—The switch assembles the output, performing the necessary translations; 9—The switch sends the output to destination; from this point on, what happens is basically a repetition of this flow for the remaining transaction stages, since, when receiving a request response, the switch regards it as a new input (the same happens to confirmation), and the recipients are inverted during the total flow (from the terminal to the Financial Institution and from the Financial Institution to the terminal).

15. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the switch solution performs actions contrary to the performed during the translations, in the moment it normalizes an input with internally known contents, this being also true to owner networks outsourcings in which the Company develops the applications executed at terminals.

16. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein, whenever there is an input at the switch, it will perform some basic validations, which are: 1—Presence of the minimal information set for routing; 2—Kind of information; 3—Message integrity.

17. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the validity of indicated origin is checked through an input at the switch, that is, whether it came from a capture point or from a Financial Institute that really exists and is qualified to perform transactions.

18. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the transaction which authenticates the terminal user is based in a valid card database, offering basic database functionalities (inclusion, exclusion and consultation) and reporting authentication errors that may happen in order for them to be consulted afterwards and to be a statistics generating source.

19. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein the switch solution provides cryptography keys exchange that ensures periodical ATN transport and master keys substitution; being possible, beyond that, to change the transportation key present in the input (coming from a terminal) to the transport key of the Financial Institution, in the output composition; the cryptography may be performed by software or by hardware, depending on the Financial Institution or on the terminal defined configurations.

20. “METHOD FOR PROCESSING AND ROUTING FINANCIAL TRANSACTIONS FROM CAPTURE POINTS AND AUTHORIZED BY FINANCIAL INSTITUTIONS, IMPLEMENTED THROUGH SOFTWARE”, according to claim 1, wherein when the password treatment is configured to be performed by hardware, the transport key replacement is performed by a hardware known as HSM, and in case of cryptography by software the exchange of the transport key is performed by the Company cryptography server.

21. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with the claim 1 and wherein the switch's sending transaction information to all of the back-up systems which happen to use them—generating a minimum level of alterations in such systems—and providing the following pieces of statistical information pertinent to the processing of entries and exits: 1—Minimum, mean, and maximum times of each entry or exit from the system; 2—Response times of the FI; 3—Number of entries/exits per period; 4—Number of timeouts.

22. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the switch's reporting occurrences informed by the terminals to the back-up systems which are responsible for their administration.

23. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the solution switch will record all the history of alterations in the configurations, thus making it possible to identify which were the then-going values at any moment in the past.

24. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the system provides a set of auxiliary pieces of information for the operation of the system, which are maintained by the graphic interface, with operations of register, consultation, removal, and updating of information, more specifically: 1—BIN/set of BINs; 2—Destination Address; 3—Authorizing entity; 4—Terminal Groups; 5—Configurations of Encryption; 6—Information from the Terminals; 7—Information from the Financing Institutions/Authorizing Entities.

25. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the following pieces of information are obtained through the process of loading from other corporate systems: 1—City; 2—Network; 3—Terminal; 4—Identification of the terminal; 5—Region; 6—City; 7—Application Version; 8—Sponsors; 9—Financial Institution; 10—Versions of ATM application.

26. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the pieces of information in below are kept in files, or data base tables (without graphic interface): 1—Code of Response from the Financial Institution; 2—Code of TecBan Response; 3—Communication Protocol Version; 4—Transaction/Service or set of transactions/services: 5—Code of Message; 6—Code of Processing; 7—Internal Code of Service.

27. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method foresees a realization of the necessary behavior for making the switch of a transaction of debit withdraw composed of solicitation, response and confirmation; this transaction is flexible to work with Financial Institutions with operate with confirmation/canceling or not.

28. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method performs the necessary treatment for the routing of a transaction of balance composed of solicitation, response, and confirmation in the route ATM-switch, at the same time that the transaction is treated only with solicitation and response in the route switch-Financial Institution.

29. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method performs the necessary behavior for the routing of a transaction of financial statement, foreseeing the flow of Financing Institutions which operate with multiple messages of response for a single transaction.

30. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method incorporates the necessary behavior for the treatment of a transaction of consultation of register information; the transaction will be utilized by the terminal to obtain register information on the bearer of the card, and the treatment performed by the switch foresees a consultation to an internal system of the company in order to obtain a list of available transactions for the card, being that the transaction still foresees a consultation to Financial Institution in order to obtain the Positive Identification of the client, where the switch will be the responsible for binding both responses, being that only a single response message will be sent to the terminal.

31. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method enables independence between the components which treat the financial transactions and, for such, it is necessary a configuration in the solution that indicates to which component a given entry message must be directed, that is, the relevant pieces of information for differentiating one service from the other are the following: 1—Identification of the transaction (code of message, code of processing); 2—Network; 3—Terminal; 4—BIN or set of BINs; 5—Version of the Terminal; 6—Version of the Communication protocol.

32. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method foresees documentation requirements, such as: 1—Development manuals in order to minimize the length of time required to enable new developers in the solution; 2—User manuals; 3—System administration manuals.

33. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method foresees the following requisites for the system: 1—Visual presentation (configuration interfaces) based on the utilization of Web technology (navigators) for available configurations for ordinary users; 2—Use of XML files for configurations of functionalities available to the developers; 3—Availability of the switch core 24×7; 4—The services are independent in what regards their maintenance, packaging, and implantation, with the possibility of Network grouping (Financial Institution A, Financial Institution B, 24-Hour Banking network, etc) and sets of business transactions; 5—The switch solution foresees information for the back-up systems through the on-line publication of the pieces of information regarding the transactions using, to that end, an integration software; 6—Utilization of relational data base; 7—Development structure (codes, components, versioning environment) which enables expeditiousness in the construction of new transactions through implementation parallelism for the following business axes: Transactions/Group of Transactions; ATM Network (Financial Institution A, Financial Institution B, 24-Hour Banking Network).

34. “METHOD FOR TREATMENT AND ROUTING OF FINANCIAL TRANSACTIONS FROM CAPTURE POINTS AND AUTHORIZED BY THE FINANCING INSTITUTIONS, IMPLEMENTED THROUGH SOFTWARE”, in accordance with claim 1, wherein the method foresees the following performance requisites: 1—The solution supports a minimum of 75 financial transactions per second, considering a set of machines whose added-up capacity is 100,000 TPM (according with definitions from the TPC). These machines are distributed for utilization of the data base system and of the application servers; 2—The sum of the times for treatment of each rout of the transaction must not surpass 1 second.
